(19) United States
(12) Patent Application Publication
(10) Pub. No.: US 2018/0232763 A1
(43) Pub. Date: Aug. 16, 2018

(54) SYSTEM AND METHOD FOR CREATING SHOPPERS GAZE, IMPLICIT INTEREST, IDENTITY AND SOCIAL NETWORK BASED INFORMATION DISBURSEMENT SYSTEM & COMBO DEALS

(71) Applicant: International Business Machines Corporation, Armonk, NY (US)

(72) Inventors: Karan Ahuja, New Delhi (IN); Ruchika Banerjee, Bangalore (IN); Kuntal Dey, New Delhi (IN); Saiprasad Kolluri Venkata Sesha, Bengaluru (IN); Seema Nagar, Bangalore (IN)

(21) Appl. No.: 15/430,603

(22) Filed: Feb. 13, 2017

(51) Int. Cl. G06Q 30/02; G06Q 50/00

(52) U.S. Cl. CPC G06Q 30/0255; G06Q 50/01; G06Q 30/0268; G06Q 30/0267; G06Q 30/0276

(57) ABSTRACT

A computerized sales tool used to stimulate sales of products and related products in a retail outlet. The tool comprises an in-store computer server, a database that stores shoppers' shopping profiles, a computer based, intelligent information retrieval system, and gaze sensors and shopper identification sensors mounted on a product rack in a store. A shopper using a mobile computing device is identified by the shopper identification sensor and the gaze sensor senses the shopper's interest in a product. Using this data, coupled with the shopper's profile and social media contact data, the computer server generates a first offer relating to the product being observed and a second offer combining the product being observed with another related product. These offers are presented to the shopper at the time of check-out or while in the store.

### REFERENCE TO RELATED APPLICATION

N/A

### BACKGROUND

### 1. Field of Invention

The present invention relates generally to computer-based sales tools, and more particularly to such tools that rely upon the real-time processing of sensed acquired data, personal historic data, and relational data.

### 2. Background of Art

Use of sensor based technologies coupled with intelligent computing systems has made it possible to more effectively and efficiently present individual consumers with information and product/service offers that are customized to their personal likes and needs. One area where such customization of product information presentation is well known is on social media platforms. Based on digital observation and database construction and correlation and already armed with a person's access information (e.g., IP address of mobile computing device), social media platform operators are able to transmit customized product advertisements and offers to a particular person's computing device. Likewise, web browsers, websites, blogs, and other digital content delivery platforms and applications can do the same. With an interconnected, open digital network, such as the Internet, a person's browsing habits, interests, and the like all become perfectly traceable. By collecting such data, personalized advertising practices have become not only possible but quite ubiquitous.

Inclusive amongst the data collecting tools used is gaze tracking. In an in-store application gaze tracking involves use of sensors, cameras or other tools that digitally observe a product that a person is inspecting along with the duration the person's interest in the product is maintained. The logic behind this, of course, is that the longer a person gazes upon a product, the more likely it is that the person in interested in purchasing the product. Thus, if it is sensed that a person gazes upon a product for a certain period of time but does not actually purchase the product, advertisements or other information about the product can be served to the person at a later time in an effort to spur that person to then purchase the product.

Another well-known tool for serving individuals with advertisements or product offers is premised upon identifying the individual based on the location of the individual. For example, an individual can be identified by his or her mobile device using an RFID or NFC type tracking device, or other sensor, and his or her location can be determined based on GPS data collected by the mobile device. Thus, it is now common for product offers for a particular retail outlet to be served to an individual's mobile device when that individual is in physical proximity to the retail outlet (e.g., when walking on a street passed a STARBUCKS coffee shop, an individual may be served with an offer to purchase a coffee based beverage at Starbucks, thereby enticing the individual to conveniently make a purchase at that point in time).

An additional known tool for providing information about a product or service based upon a query is computer-based information retrieval systems (e.g., IBM's WATSON computer system, Apple's SIRI system, Microsoft's CORTANA system, etc.). These systems can, among other things, provide answers/information about a particular product or service based upon an input of data concerning or relating to such product/service. Thus, such systems are useful at enhancing advertisements and product offers by increasing the amount of information a consumer is given concerning the product or service.

There are applications of sensor and computer technology that have yet to be conceived of and developed for purposes of enhancing a shopper's in-store experience and to present relevant shopping offers in-store, in real time at the time of purchase.

### SUMMARY OF THE INVENTION

The present invention provides a computerized sales tool used to stimulate sales of products and related products in a retail outlet.

In an embodiment of the present invention, a system for presenting a person with product offers, comprising (i) a server computer having a non-transitory memory; (ii) a first computer in communication with the server computer and having non-transitory memory; (iii) a first sensor for collecting first data representative of a product being observed by the person, the first data being stored in the non-transitory memory of said the server computer; (iv) a second sensor for collecting second data representative of the person, the second data being stored in the non-transitory memory of the server computer; (v) a social media computer based network having data representative of the person's social media contacts stored therein; (vi) a database stored in non-transitory memory of said first computer and storing data therein representative of the person's shopping history and profile, the database receiving said first data and said second data for storage in the person's the profile; (vii) an intelligent, computer based information retrieval system; and (viii) a first computer program stored in the non-transitory memory of the server computer comprising first program instructions to receive the first and second data from the database, second program instructions to construct a first sales offer for the product, third program instructions to construct a second sales offer for a combination of the product and a second product, fourth program instructions to access the social media contact data; and fifth program instructions to generate and transmit a query about the product to the intelligent, computer based information retrieval system.

In an aspect of the invention, a computer program product for generating and presenting an offer regarding a first product to a shopper shopping in a retail outlet is provided, comprising (i) program code for receiving and processing data representative of the shopper's identity and geographic location; (ii) program code for receiving and processing data representative of the shopper's first product observations, and storing the data representative of the shopper's first product observations in a database that correlates the data with the shopper; (iii) program code for accessing data representative of the shopper's profile that is stored in a database; (iv) program code for querying a computer-based intelligent information retrieval system about the first product; (v) program code for accessing data associated with the shopper's social media contacts; (vi) program code for inferring the shopper's interest in the first product based on processing of said data representative of the shopper's first product observations and the shopper's profile data; (vii) program code for determining the shopper's likely interest in a second product related to the first product based on processing of the data associated with the shopper's said social media contacts and the data representative of the shopper's first product observations; (viii) program code for generating a first offer related to the first product and a second offer related to a combination of the first product and said second product; and (ix) program code for presenting the first and second offers to the shopper.

In another aspect of the invention, a method for generating and presenting an offer regarding a first product to a shopper shopping in a retail outlet, comprising the steps of: (i) receiving and processing data representative of the shopper's identity and geographic location; (ii) collecting, receiving and processing data representative of the shopper's first product observations, and storing the data representative of the shopper's first product observations in a database that correlates the data with the shopper; (iii) accessing data representative of the shopper's profile that is stored in a database; (iv) querying a computer-based intelligent information retrieval system about the first product; (v) accessing data associated with the shopper's social media contacts; (vi) inferring the shopper's interest in the first product based on processing of the data representative of the shopper's first product observations and the shopper's profile data; (vii) determining the shopper's likely interest in a second product related to the first product based on processing of said the data associated with the shopper's the social media contacts and the data representative of the shopper's first product observations; (viii) generating a first offer related to the first product and a second offer related to a combination of the first product and said second product; and (ix) presenting the first and second offers to the shopper.

### BRIEF DESCRIPTION OF THE DRAWINGS

The present invention will be more fully understood and appreciated by reading the following Detailed Description in conjunction with the accompanying drawings, in which:

FIG. 1 is a block diagram illustrating a preferred system architecture in accordance with an embodiment of the invention;

FIG. 2 is a data flow diagram in accordance with an embodiment of the invention;

FIGS. 3A and 3B are flow charts in accordance with an embodiment of the invention.

### DETAILED DESCRIPTION

Referring now to the drawings, wherein like reference numerals refer to like parts throughout, an embodiment of the present invention, is presented. In an embodiment of the present invention, a computer-based computer program product, system and methodology are provided for presenting a shopper 10 with real-time shopping offers associated with a product being observed as well as offers for combinations of products including a product being observed wherein the other products in the combination offer are deterministically related to the product being observed. The product offer or combination offers can be presented to the shopper 10 on the shopper's mobile computing device (e.g., smart phone, tablet, or like device) 100 or at a check-out terminal 12 at the time of purchase. The product offer or combination offers are generated through computer analytics that process data types being input to a computer 200, running the analytics software, from several sources, including, for example, data representative of the shopper's current browsing pattern, data representative of the shopper's social network and other personal contacts and those persons' purchasing behaviors, the shopper's historic purchasing behaviors. In addition and as an intermediary in the product offer generation, an intelligent computing information retrieval system 500 (e.g., IBM's WATSON system or Apple's SIRI system) is engaged to provide shopper 10 with real-time information concerning the product then being browsed.

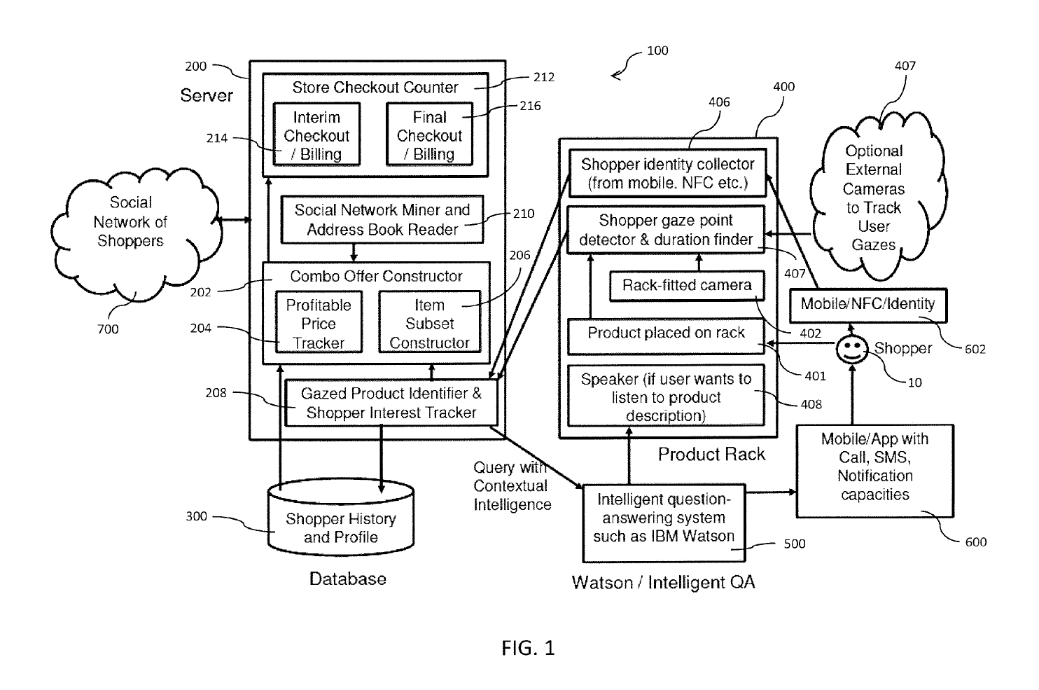

Referring to FIG. 1, the architecture of computer system 100 used to generate shopping offers and combination offers is provided. Computer system 100 essentially comprises a server computer 200, typically, but not necessarily, located in a retail store; a database 300 (stored in the memory of computer server 200, a different in-store computer, a remote computer owned by the retail parent, or on a hosted computer operated by a third party which could be cloud-based or a dedicated server computer) that contains data representative of individual shoppers and their profiles (including, for example, online activities, posts, reviews, etc.—inference can be done by third-party systems the interests of the individuals, the shopping history to the extent possible (portions of which is based upon data entered by the individual, while other portions are inferred and input from an inference engine), and permitted level of access to similarly constructed profile data of their social friends); a product rack 400 (or other structure in physical proximity to particular products) located in a retail facility (typically the same retail facility as server computer 200 is located); computer based intelligent information retrieval system 500; and a mobile computing device 600 associated with shopper 10. Each of these components, in turn, contain many other components as will be described in greater detail hereinafter.

Computer server 200 includes non-transitory memory in which is stored a computer program product (a “combo offer constructor”) 202 that contains computer readable program instructions to, inter alia, generate offers associated with a product that shopper 10 is simultaneously observing within the retail facility (a “product offer”) 204, as well as generate offers of the product that shopper 10 is simultaneously observing within the retail facility in combination with other, related types of products/services (a “combination offer”) 206. Further contained within server 200 is a computer module 208 for receiving (1) data representative of the product that is the subject of the shopper's gaze and duration of his/her gaze, and (2) data representative of the identity of the shopper 10. Module 208 transmits the received data to database 300 for storage therein within the corresponding data fields. Further contained within server 200 is a computer program module 210 comprising computer readable program instructions for reading social network contact data associated with shopper 10 and electronic address book data associated with shopper 10 for purposes of mining and analyzing such data and providing analytics associated therewith to offer constructor 202 for further processing therein. To enhance the analytics associated with the social media data, server 200 also communicates with the social media networks of others discovered from the shopper's 10 social media contacts. This permits the an additional component contained within server 200 is a computer program checkout module 212 that generates an offer presented with an interim checkout bill 214 (that may contain, for example, an offer to make a purchase that was determined by offer constructor program 202 to be attractive to shopper 10) and a final checkout bill 216 that represents the final bill for shopper 10 based on all purchases made in that particular visit. Checkout module 212 interfaces with a checkout terminal within the retail facility for presentment to the shopper 10 at the time of checkout.

Product rack 400 is equipped with several components integral to system 100 as well. Product rack 400 includes at least one product 401 stored thereon and includes a rack fitted camera 402 that functions to record shopper 10 as he/she observes a particular product on rack 400. Camera 402 provides the captured imagery to a sensor 404 that determines the shopper's gaze point (i.e., what exact product the shopper is looking at) and the duration of the gaze (i.e., how long shopper 10 looked at the product). Sensor 404 may also receive gaze data from external cameras 407 positioned for tracking the gazes of shopper 10. Sensor 404 transmits the sensed data to module 208 as previously described. Further contained within product rack 400 is a shopper identity sensor/collector 406 (e.g., near field communication receiver) which collects data representative of the shopper's 10 identity via NFC, mobile number or other ID, or the like 602 that may be transmitted or sensed from mobile computing device 600. The identity data collected by sensor/collector 406 is transmitted to module 208 as previously described.

System 100 further includes computer based intelligent information retrieval system 500. Information retrieval system 500 receives contextual queries from module 208 (e.g., product identification and gaze data of a particular shopper). In response to the contextual query received from module 208, information retrieval system 500 sends responsive data that is translated into human readable language to a speaker 408 (or other notification device such as a display, for example) positioned on, in, or in operatively close proximity to rack 400. In addition, information retrieval system 500 will provide the data that is translated into human readable language to mobile computing device 600 for display as an SMS message, a text message, an email, or other notification means provided with mobile device 600.

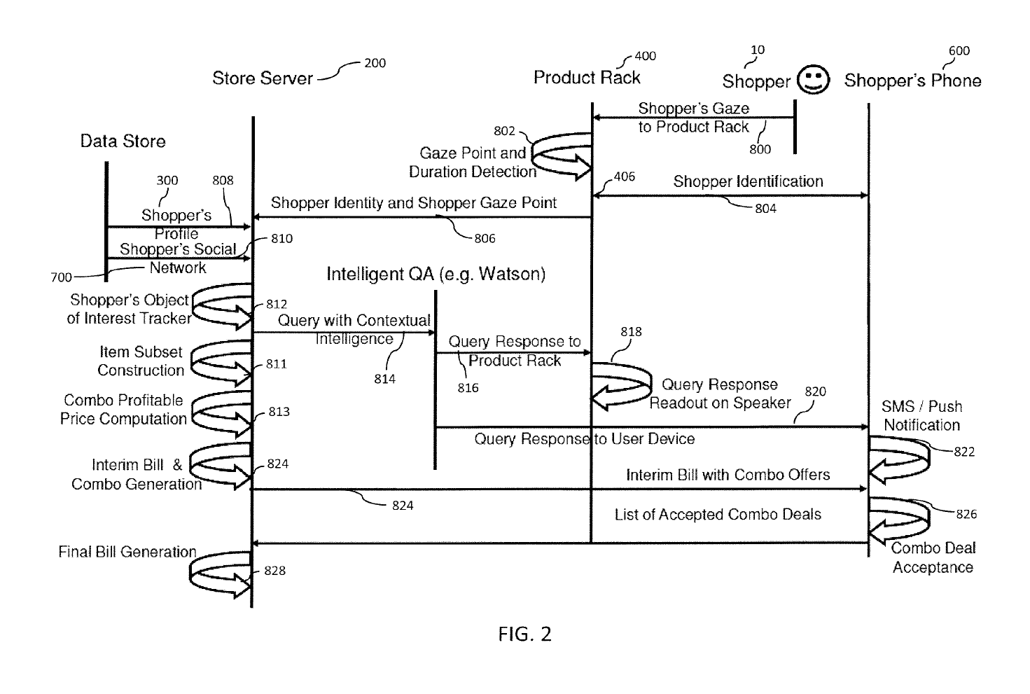

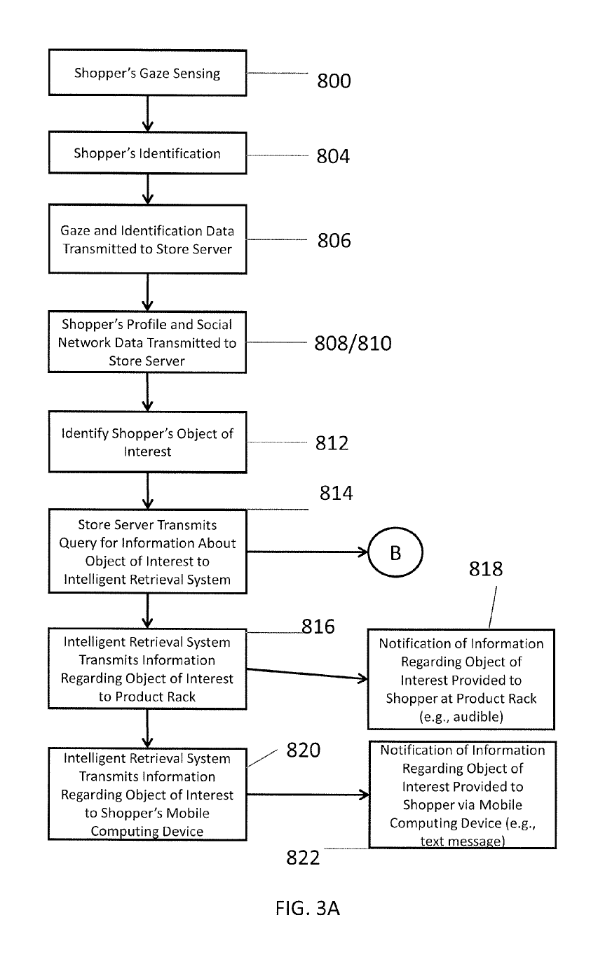

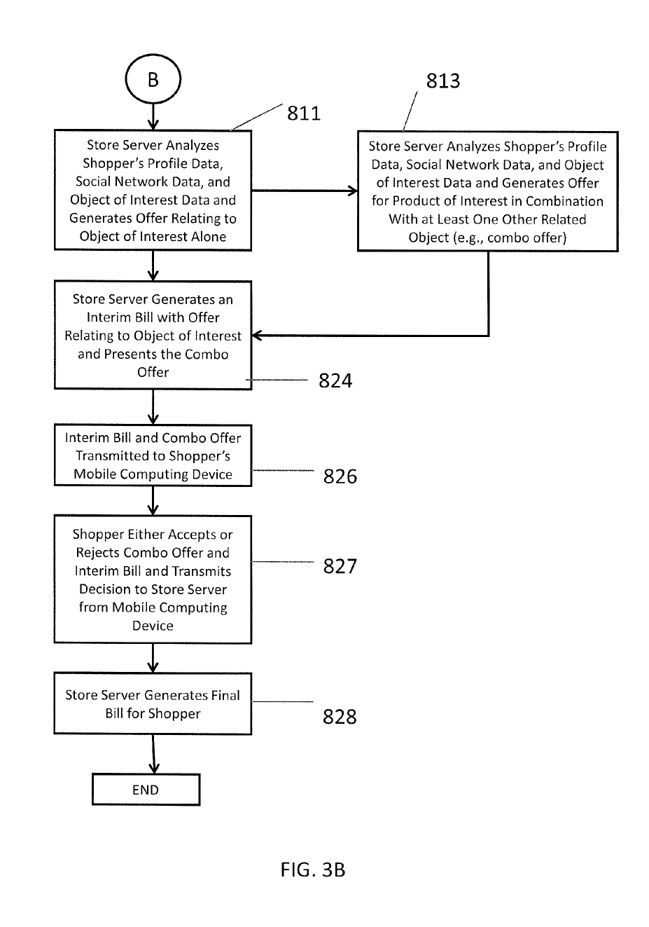

In terms of the data flow associated with system 100, reference is made to FIGS. 2, 3A and 3B. The data flow begins with shopper 10 gazing at a product 401 on a product rack 400 in step 800. Sensor 404 will detect and record data associated with the gaze in step 802. Simultaneously, the shopper's mobile computing device 600 will send data to sensor/collector 406 in step 804. The shopper's gaze point data and identification data will then be transmitted to server 200 (module 208 in server 200) in step 806. Next, the shopper's profile from database 300 and his/her social media contact data from network 700 will be transmitted to server 200 in steps 808/810. The shopper's product of interest is identified within server 200 based on the data thusly provided in step 812 and a query is transmitted to intelligent information retrieval system 500 in step 814. The intelligent information retrieval system 500 then determines product information associated with the product of interest and transmits that information in human readable form to rack 400 (and more particularly to speaker 408) in step 816, and speaker 408 provides shopper 10 with the product information in step 818. The intelligent information retrieval system 500 then transmits the product information gathered in response to its query to mobile computing device 600 (via SMS/Push notification or other communications protocol) in step 820 where it is displayed to shopper 10 (via SMS/Push notification or other communications protocol) in step 822. While the additional product information is being provider to shopper 10, using all of the collected data, the computer program 202 running on server 200 can generate dynamic pricing offers for the product of interest in step 811 and also produce combination price offerings 813 including not only the product of interest but also related products gleaned from the shopper's user profile and social media contact data. An interim bill can then be generated at store server 200 in step 824 and presented to shopper 10 on his/her mobile computing device in step 826 where the shopper can accept any of the offers contained therein in step 827 and then a final bill can be generated in server 200 and presented to shopper 10 on his/her mobile computing device 600 in step 828 based on the Shopper's actual purchases (e.g., adding in whatever Shopper 10 actually purchased plus any of the offers and/or combo offers that had been presented and accepted).

Several examples can illustrate the practical output resulting from use of an embodiment of the present invention.

### EXAMPLE 1

### Social Activity

During checkout, Karan has just now qualified for a 12% discount if he buys a Pepe Jeans and a Woodlands Shoe together, given that he has purchased a Monte Carlo T Shirt (he had intently/for long gazed at Pepe Jeans and Woodland Shoes).

However, the system detects that Ruchika, who is one of Karan's top contacts in Karan's phone frequent callers list, had gazed intently at a Monte Carlo T Shirt, and also had bought a Pepe Jeans, but did not look intently at a Woodlands Shoe (had “saccade”ed past Woodland Shoe).

So, Karan is also offered a 11% discount if he buys a Pepe Jeans (but not a Woodlands Shoe), given he has purchased a Monte Carlo T Shirt.

### EXAMPLE 2

### Social Analytics

Sam is 25 years old, is interested in branded casual t-shirts, funky shoes and ties based on his user profile.

The store has an in-house analytics social profiling platform that provides the granular profiling of users.

Sam's profile is stored by default on his smartphone.

This profile is comprised of his preferences, products that he has gazed at and a wish list.

Sam has gazed at a branded casual t-shirt and moves to the next aisle.

Sam has given permission to the app to access his social network contacts and phone address book.

When he moves, he gets a notification on his phone about possible recommendations based on a social profile mapping to other shoppers in the store.

Ex. If there are other 20-30 year olds who have previously bought/currently buying linen jackets, and/or if three of his close friends has recently purchased a linen jacket, then it would give out a recommendation to pick up a linen jacket as part of the combo deal offer.

Ex. If Sam wants to buy something funky for his girlfriend, he moves to the ladies section. In this setting, Sam is shown combo deals based upon the items that he has gazed at, that tend to be gazed and/or purchased with other items together by females (as found using user profiles gathered from phones and social network profiles gathered from the permitted apps).

### EXAMPLE 3

### Full Product

Karan looks intently at a Pepe Jeans rack (and happens to pick up one).

He also looks intently at a Monte Carlo T-Shirt.

At this instant, he gets a push notification (or SMS) on his phone that, he will receive a special 10% discount if he picks up both the Pepe Jeans and a Monte Carlo T Shirt.

Karan (incidentally, without picking up the T Shirt), continues shopping around.

He likes a Woodlands Shoe, and looks at it very carefully.

The camera finds his intent gaze at the Woodland Shoe rack.

He is offered a 15% discount if he buys a Pepe Jeans, a Monte Carlo T Shirt and a Woodlands Shoe together.

He is also offered a 12% discount if he buys a Pepe Jeans and a Woodlands Shoe together.

Karan walks over to the fast food section.

He moves fast (“saccades” over a few pizzas, and stop at Fourt Cheese Pizza rack, and intently looks at their pizzas (but does not pick up).

He also looks intently at White Sauce Corp's sauces.

And, he gets a “buy a Four Cheese Pizza and get a 30% off on White Sauce Corp” offer.

But he does not pick up.

After shopping, Karan moves ahead to the checkout section.

An interim billing system finds that Karan has purchased a Pepe Jeans.

So before being asked to pay, Karan is shown a down-sell (discount) option for 25% discount if he buys a Monte Carlo T Shirt and a Woodlands Shoe together, given that he has already purchased Pepe Jeans.

He is also shown a discount of 20% if he buys Four Cheese Pizza and White Sauce Corp together.

Karan decides whether he wants to accept any of these offers, and accordingly completes shopping by picking/not picking up and making final payment.

### EXAMPLE 4

### Part of Product

Ruchika has become health-conscious of late.

While buying food items, she always looks at the ingredients/composition.

So, while in the retail store, she tends to look intently at the composition/ingredient section of the food items.

One of more cameras identify the fact that (a) Ruchika is looking at a food item and (b) the face of the package of the food item she is looking at, is the one with the ingredient composition description.

A call comes onto Ruchika's phone (or shopping store app), and that reads out the composition of ingredients, the benefits and restrictions/contraindications etc. of the product.

Ruchika keeps shopping, and frequently keeps looking at items that have high first class protein content.

Sometime down the line, she gets a note (sms/push notification) on her phone or app, suggesting a few items in the store that are high in first class protein, along with discount incentives.

Based upon Ruchika's purchase decisions of food items and these observed trends, she is also offered some combo (combined) offers at checkout, with certain items and discounts.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1) A system for presenting a person with product offers, comprising:
(a) a server computer having a non-transitory memory;
(b) a first computer in communication with said server computer and having non-transitory memory;
(c) a first sensor for collecting first data representative of a product being observed by the person, said first data being stored in said non-transitory memory of said server computer;
(d) a second sensor for collecting second data representative of the person's identity, said second data being stored in said non-transitory memory of said server computer;
(e) a social media computer based network having data representative of the person's social media contacts stored therein;
(f) a database stored in non-transitory memory of said first computer and storing data therein representative of the person's shopping history and profile, said database receiving said first data and said second data for storage in the person's said profile;
(g) an intelligent, computer based information retrieval system; and
(h) a first computer program stored in said non-transitory memory of said server computer comprising first program instructions to receive said first and second data from said database, second program instructions to construct a first sales offer for the product, third program instructions to construct a second sales offer for a combination of the product and a second product, fourth program instructions to access said social media contact data; and fifth program instructions to generate and transmit a query about the product to said intelligent, computer based information retrieval system.

2) The system according to claim 1, wherein said first computer program further comprises program code for accessing data representative of the person's electronic contacts; program code for analyzing said data representative of the person's electronic contacts to determine purchasing behaviors of those said electronic contacts; and program code for updating said sales offer for the product based upon said analysis of said data representative of the person's electronic contacts.

3) The system according to claim 1, wherein said first sensor comprises a gaze point detector operably positioned relative to the product.

4) The system according to claim 3, wherein said gaze point detector comprises a camera.

5) The system according to claim 1, wherein said second sensor comprises a mobile phone reader.

6) The system according to claim 5, wherein said mobile phone reader comprises near field communication cards coupled with active near field communication readers operably positioned relative to the product.

7) The system according to claim 1, further comprising a personal computing device having non-transitory memory, and a second computer program stored in said non-transitory memory of said personal computing device comprising program instructions to transmit said sales offer to the person.

8) The system according to claim 7, wherein said second computer program comprises program code to authorize accessing social media contact lists from the personal computing device.

9) A computer program product for generating and presenting an offer regarding a first product to a shopper shopping in a retail outlet, comprising:
(a) program code for receiving and processing data representative of the shopper's identity and geographic location;
(b) program code for receiving and processing data representative of the shopper's first product observations, and storing said data representative of the shopper's first product observations in a database that correlates said data with the shopper;
(c) program code for accessing data representative of the shopper's profile that is stored in a database;
(d) program code for querying a computer-based intelligent information retrieval system about the first product;
(e) program code for accessing data associated with the shopper's social media contacts;
(f) program code for inferring the shopper's interest in the first product based on processing of said data representative of the shopper's first product observations and said shopper's profile data;
(g) program code for determining the shopper's likely interest in a second product related to said first product based on processing of said data associated with the shopper's said social media contacts and said data representative of the shopper's first product observations;
(h) program code for generating a first offer related to said first product and a second offer related to a combination of said first product and said second product; and
(i) program code for presenting said first and second offers to the shopper.

10) The computer program product according to claim 9, wherein said data representative of the shopper's first product observations comprises data representative of the shopper's first product fixed observation duration, and first product saccade count.

11) The computer program product according to claim 9, wherein said program code for presenting said first and second offers to the shopper comprises computer program code for transmitting said first and second offers to a mobile computing device associated with the shopper.

12) The computer program product according to claim 9, wherein said program code for presenting said first and second offers to the shopper comprises computer program code for transmitting said first and second offers to a computer positioned at a check-out terminal in the retail outlet.

13) A method for generating and presenting an offer regarding a first product to a shopper shopping in a retail outlet, comprising the steps of:
(a) receiving and processing data representative of the shopper's identity and geographic location;
(b) collecting, receiving and processing data representative of the shopper's first product observations, and storing said data representative of the shopper's first product observations in a database that correlates said data with the shopper;
(c) accessing data representative of the shopper's profile that is stored in a database;
(d) querying a computer-based intelligent information retrieval system about the first product;
(e) accessing data associated with the shopper's social media contacts;
(f) inferring the shopper's interest in the first product based on processing of said data representative of the shopper's first product observations and said shopper's profile data;
(g) determining the shopper's likely interest in a second product related to said first product based on processing of said data associated with the shopper's said social media contacts and said data representative of the shopper's first product observations;
(h) generating a first offer related to said first product and a second offer related to a combination of said first product and said second product; and
(i) presenting said first and second offers to the shopper.

14) The method according to claim 13, wherein said step of collecting data representative of the shopper's first product observations comprises sensing the shopper's first product fixed observation duration, and sensing the shopper's first product saccade count.

15) The method according to claim 13, wherein said step for presenting said first and second offers to the shopper comprises transmitting said first and second offers to a mobile computing device associated with the shopper.

16) The method according to claim 13, wherein step for presenting said first and second offers to the shopper comprises transmitting said first and second offers to a computer positioned at a check-out terminal in the retail outlet.
